(19) United States
(12) Patent Application Publication
(10) Pub. No.: US 2013/0332967 A1
(43) Pub. Date: Dec. 12, 2013

(54) COMBINED TERRESTRIAL AND SATELLITE CONTENT FOR A SEAMLESS USER EXPERIENCE

(71) Applicant: Glenn Chang, Carlsbad, CA (US)

(72) Inventor: Glenn Chang, Carlsbad, CA (US)

(21) Appl. No.: 13/906,933

(22) Filed: May 31, 2013

Related U.S. Application Data
(60) Provisional application No. 61/658,445, filed on Jun. 12, 2012.

(51) Int. Cl. H04H 40/90; H04N 21/61

(52) U.S. Cl. CPC H04H 40/90; H04N 21/6143
USPC 725/68; 455/3.02

(57) ABSTRACT

A signal reception assembly may comprise a housing configured to support receipt and handling of a plurality of signals, including signals from different sources. The different sources may correspond to satellite and non-satellite (e.g., terrestrial) broadcasts. The signal reception assembly may comprise a satellite reception assembly. The housing may comprise circuitry incorporating an integrated stacking architecture for supporting and/or providing channel and/or band stacking whereby particular channels or bands, from satellite signals that are received via a satellite capturing component (e.g., satellite dish) and from terrestrial signals that are received via a terrestrial reception component (e.g., diversity terrestrial antenna), may be combined onto a single output signal that may be communicated from the signal reception assembly to a gateway device (e.g., STB).

### CLAIM OF PRIORITY

This patent application makes reference to, claims priority to and claims benefit from the U.S. Provisional Patent Application Ser. No. 61/658,445, filed on Jun. 12, 2012.

This patent application also makes reference to:
U.S. application Ser. No. 13/762,939, having the title of “METHOD AND SYSTEM FOR COMBINED TERRESTRIAL AND SATELLITE CONTENT FOR A SEAMLESS USER EXPERIENCE,” which was filed on Feb. 8, 2013.

Each of the above stated applications is hereby incorporated herein by reference in its entirety.

### TECHNICAL FIELD

Aspects of the present application relate to communications. More specifically, certain implementations of the present disclosure relate to combined terrestrial and satellite content for a seamless user experience.

### BACKGROUND

Existing methods and systems for delivery of non-satellite content (e.g., terrestrial content) to satellite customers can be costly, cumbersome and inefficient. Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for combined terrestrial and satellite content for a seamless user experience, substantially as shown in and/or described in connection with at least one of the figures, as set forth more completely in the claims.

These and other advantages, aspects and novel features of the present disclosure, as well as details of illustrated implementation(s) thereof, will be more fully understood from the following description and drawings.

### BRIEF DESCRIPTION OF SEVERAL VIEWS OF THE DRAWINGS

FIG. 1 illustrates an example home network that supports reception of satellite and non-satellite broadcasts.

FIG. 2 illustrates an example satellite receiver assembly that supports reception of non-satellite broadcasts.

FIG. 3 illustrates an example housing component of a satellite television receiver assembly that may support integrated stacking.

FIGS. 4A and 4B illustrates example stacking schemes that may be implemented by a system configured to support use of integrated stacking while combining satellite content and non-satellite content onto a single physical channel for conveyance to a gateway/set-top box (STB).

FIG. 5 illustrates an example of a non-satellite receiver and re-modulator that may be used in a system that is operable to combine satellite and non-satellite contents for a seamless user experience.

FIG. 6 illustrates an example stacking switch as may be in a system that is operable to combine satellite and non-satellite contents for a seamless user experience.

FIG. 7 illustrates an example flow chart of a process for receiving and combining of satellite and non-satellite contents for a seamless user experience.

FIG. 8 illustrates an example flow chart of a process for configuring a system for receiving and combining of satellite and non-satellite contents for a seamless user experience.

### DETAILED DESCRIPTION

Certain implementations of the invention may be found in method and system for combined terrestrial and satellite content for a seamless user experience. As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first plurality of lines of code and may comprise a second “circuit” when executing a second plurality of lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be performed by one or more circuits. As utilized herein, the term “example” means serving as a non-limiting example, instance, or illustration. As utilized herein, the terms “for example” and “e.g.,” introduce a list of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

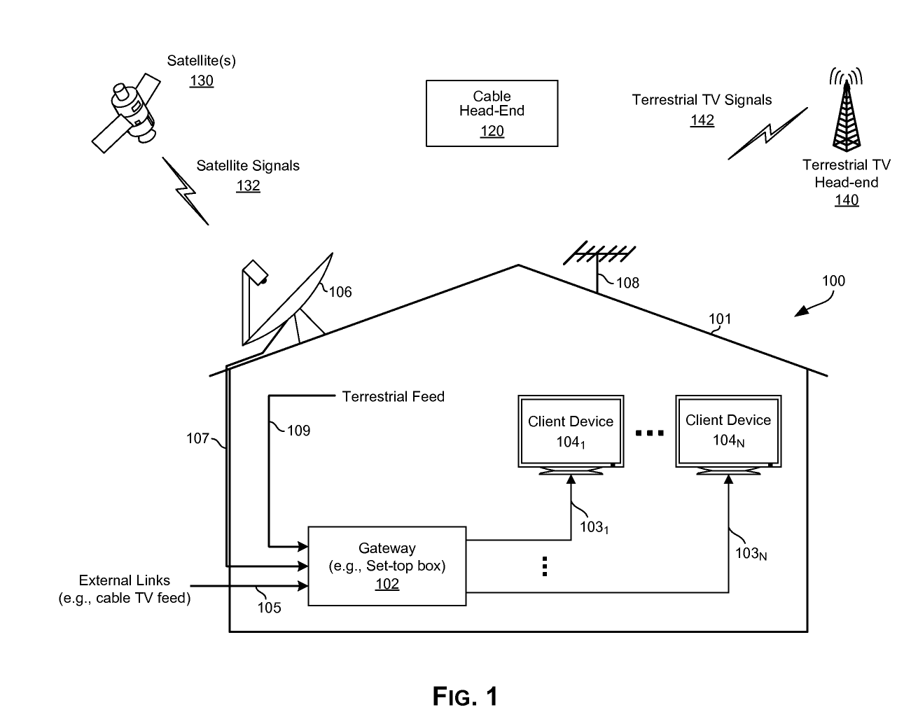

FIG. 1 illustrates an example home network that supports reception of satellite and non-satellite broadcasts. Referring to FIG. 1, there is shown an in-premises network 100.

The in-premises network 100 may be configured to service particular premises 101 (e.g., residential or commercial). In this regard, the in-premises network 100 may be configured to provide and/or enable broadband and/or television (or other similar content broadcast) access in the premises 101. The in-premises network 100 may comprise, for example, a gateway 102 and a plurality of client devices 104₁-104_{N}. In this regard, the gateway 102 may comprise suitable circuitry, interfaces, logic, and/or code for enabling servicing a plurality of client devices (e.g., the client devices 104₁-104_{N}), which may comprise devices that may communicate with the gateway 102 via one or more point-to-point media links (e.g., HDMI, Display Port, analog video links, analog video links, or the like). The client devices 104₁-104_{N} may comprise televisions and similar devices that may be used in displaying or playing back multimedia content that may be broadcasted (e.g., via terrestrial signals, satellite signals, cable signals, and/or over the Internet). The disclosure is not limited, however, to any particular type of client device.

The gateway 102 may be configured to support or enable providing services in the in-premises network 100. The services or functions that may be provided and/or supported by the gateway 102 may pertain to, for example, content distribution and/or broadband access in the in-premises network 100. In this regard, the gateway 102 may be configured to facilitate and/or handle reception and/or transmission of signals that may be used to enable content distribution and/or broadband accessibility in the in-premises network 100 (e.g., to the plurality of client devices 104₁-104_{N}). This may be achieved by configuring the gateway 102 to support appropriate internal and/or external connections, such as to enable connectivity to the plurality of client devices 104₁-104_{N}, and/or to various external devices, systems, or networks that may be needed. In this regard, the gateway 102 may be operable to support communications over a plurality of external links (i.e., links that may be utilized in connecting gateway 102 to external entities, such as broadcast or service head-ends), communications over a plurality of internal links (i.e., links used within the in-premises network 100, such as links 103₁-103_{N} which may be utilized in connecting the gateway 102 to the client devices 104₁-104_{N}), and/or to process signals communication over these links.

The plurality of internal links 103ᵢ may comprise wired, wireless, and/or optical links that may be suited for use in an environment such as the in-premises network 100. For example, the internal links 103ᵢ may comprise wired connections (e.g., HDMI connections, Display Port links, Multimedia over Coax Alliance (MoCA) links, or Ethernet connections), and/or wireless connections (e.g., Wi-Fi, ZigBee, wireless USB, or the like).

The gateway 102 may be operable to obtain content distributed in the in-premises network 100 from one or more broadcast head-end nodes. In this regard, the content delivered to the gateway 102 may be broadcast using wired or wireless signals. For example, the gateway 102 may be configured to terminate wired external links (e.g., link 105), which may be configured to enable communication of content from suitable head-ends over wired connections. For example, link 105 may comprise, a coaxial or twisted-pair cable and/or an optical fiber which carries physical layer symbols in accordance with, for example, DSL, DOCSIS, or Ethernet standards (e.g., to facilitate cable television, terrestrial television, and/or Internet accessibility). Accordingly, the link 105 may be utilized to enable connectivity between the gateway 102 and one or more cable (or other similar service provider) head-ends 120.

Connectivity to external/remote sources (e.g., broadcast head-ends) may also be achieved wirelessly—i.e., content may be delivered to the gateway 102 from broadcast head-ends over suitable wireless links. Wireless based connectivity may necessitate, in some instances, use of local auxiliary devices or systems for enabling the wireless communication (reception) of signals. For example, a satellite reception assembly 106 may be utilized (e.g., installed on the roof of the premises 101) to enable satellite based communications (e.g., allow reception of satellite based broadcasts, and, in some instances, transmission of—i.e. uplink, satellite communications). In this regard, a plurality of satellites 130 may be utilized to communicate satellite signals 132 (which may typically comprise only downlink communication signals, but the disclosure is not so limited). In this regard, the satellite signals 132 may be utilized to broadcast satellite television content. The satellite signals 132 may comprise, for example, K, Ka, and/or Ku band Direct Broadcast Satellite (DBS) signals. The disclosure, however, is not limited to any particular type of satellite signal. The satellite reception assembly 106 may be a satellite “dish”. In this regard, the satellite reception assembly 106 may comprise a reflector—for capturing satellite signals (e.g., the satellite signals 132), and circuitry operable to receive and to process the received satellite signals, such as to recover data carried in the satellite signals (e.g., television channels, media content, etc.), and configure a suitable output corresponding to the recovered data for transmission to other devices that may handle use and/or distribution of the data (e.g., to the gateway 102 via a link 107). The link 107 may comprise one or more wired, wireless, and/or optical links. The link 107 may comprise, for example, a wired (e.g., coaxial and/or twisted-pair) and/or wireless communication medium which carries physical layer symbols in accordance with, for example, Multimedia over Coax Alliance (MoCA), Ethernet, and/or DBS standards.

Similarly, an antenna assembly 108 may be utilized (e.g., being installed on the roof of the premises 101) to enable non-satellite based communications (e.g., reception of terrestrial TV broadcasts). In this regard, a plurality of terrestrial TV head-ends 140 may be utilized to communicate terrestrial TV signals 142 (which may typically comprise only downlink communication signals, but the disclosure is not so limited), which may be utilized to carrying broadcast terrestrial TV content. The terrestrial TV signals 142 may comprise, for example, UHF or VHF band signals, which may typically be allocated for use in terrestrial televisions broadcasts, modulated in accordance with particular analog or digital standards. Example of television modulation/transmission standards may comprise NTSC, PAL or SECAM for analog television, and ATSC or DVB standards for digital television. The disclosure, however, is not limited to any particular standard/bands for terrestrial TV signals.

The antenna assembly 108 may comprise one or more antennas (e.g., dipole and/or loop antennas) that may be configured to receive RF signals corresponding to terrestrial broadcasts (e.g., UHF or VHF band signals). In some instances, the antenna assembly 108 may be configured to support diversity reception. In this regard, in diversity reception schemes, two or more antennas may be used, to improve the quality and reliability of signal reception (e.g., allowing for reception of different instances or copies of the target signal). Use of diversity reception may be particularly desirable in certain environments, especially in urban and indoor environments, where there may be no clear line-of-sight (LOS) between transmitter and receiver, and the transmitted signal may instead be reflected along multiple paths before finally being received. In some instances, the antenna assembly 108 may comprise, in addition to the actual antennas used in receiving the over-the-air signals, circuitry for performing at least a portion of the required processing of received terrestrial TV signals (including, in some instances, recovering data carried in the signals—e.g., television channels, media content, etc.), and/or to configure an output corresponding to the recovered data that may be suitable for transmission to other devices that may handle use and/or distribution of the data (e.g., to the gateway 102, via link 109). In this regard, the link 109 may comprise one or more wired, wireless, and/or optical links. The link 109 may comprise, for example, a coaxial and/or twisted-pair cable.

The gateway 102 may be operable to receive signals communicated from external entities (e.g., cable head-ends 120, satellites 130, or terrestrial TV head-ends 140), and process the signals as necessary for obtaining data and outputting the data via corresponding signals over the internal links 103ᵢ to the client devices 104ᵢ. Similarly, the gateway 102 may be operable to receive signals communicated from the client devices 104ᵢ, over the internal links 103ᵢ, and process the signals as necessary for obtaining data and outputting the data via corresponding signals to the external entities. Accordingly, the term “gateway” in this disclosure refers to a client device which may perform satellite set-top box functions, cable television receiver functions, terrestrial television receiver functions, WAN/LAN modem functions, etc. In this regard, “satellite set-top box” functions may comprise functions utilized for delivering data from the cable head-ends, satellites, broadband head-ends, web servers, and the like to devices within the premises.

In operation, the in-premises network 100 may be setup and/or used to provide various services (e.g., broadband and/or television access) within the premises 101. In this regard, the in-premises network 100 may comprise a network configured based on one or more type(s) of interface(s) or standard(s), to interconnect various devices (e.g., the gateway 102 and client devices 104₁-104_{N}) within a physical space (e.g., the premises 101), to allow connectivity therebetween and/or to access networks (i.e., external to the premises 101). The in-premises network 100 may be setup as Internet Protocol (IP) based network, using WiFi, Ethernet, Bluetooth, and/or similar connections, and may be configured to support various IP-based services such as broadband or IP-based TV (IPTV) services. The disclosure, however, is not so limited.

In some instances, at least some of the data utilized in the in-premises network 100 may be received from external sources, such as from broadband or broadcast sources (e.g., the satellites 130, the terrestrial TV head-ends 140 and/or the cable head-ends 120). In this regard, the gateway 102 may be utilized to service the in-premises network 100, such as by providing to the client devices 104₁-104_{N} access to external networks/connections. In such instances, the gateway 102 may facilitate communication of signals between the client devices 104₁-104_{N} and the external sources. For example, the gateway 102 may be utilized to route communications between cable head-ends 120 and one or more of client devices 104₁-104_{N}. In this regard, a client device 104ᵢ may receive from the cable head-end 120 streams containing, e.g., multimedia content. In some instance, the interactions with the cable head-end may be bi-directional. For example, client device 104ᵢ may transmit to the cable head-end 120 signals or streams, such as containing user commands or requests (e.g., for particular content) or the like. Communications between client devices and head-ends may be configured in accordance with particular protocols. For example, cable communications may be configured in accordance with DOCSIS protocol(s).

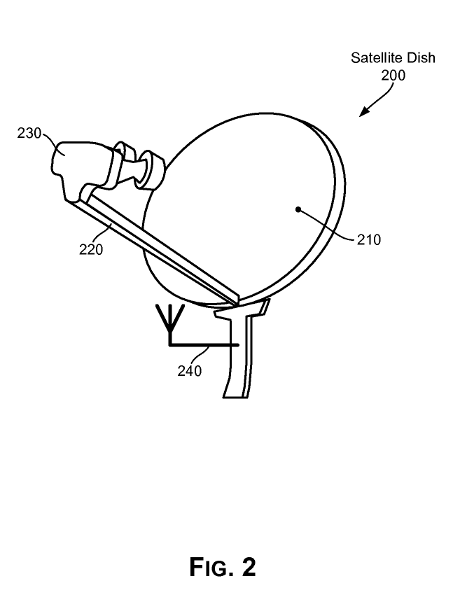

FIG. 2 illustrates an example satellite receiver assembly that supports reception of non-satellite broadcasts. Referring to FIG. 2, there is shown a satellite receiver (‘dish’) assembly 200.

The satellite dish assembly 200 may be configured to support capturing of satellite signals, and handling of the received signals (e.g., to provide feed(s) to other devices, such as satellite set-top boxes or other devices that can extract and process satellite content). The satellite dish assembly 200 may be similar to the satellite reception assembly 106 of FIG. 1, for example. The satellite dish assembly 200 may comprise a reflector 210, a boom 220, and a signal processing assembly 230. In this regard, the reflector 210 may be a concave structure for reflecting electromagnetic waves (e.g., satellite signals) toward a focal point. The reflector 210 may be substantially parabolic in shape and may be made of, for example, fiberglass and/or metal. The boom 220 may be configured such that the signal processing assembly 230 to be mounted or placed at or near the focal point of the reflector 210, to ensure optimal capturing of satellite signals via the reflector 210. The signal processing assembly 230 may comprise circuitry for receiving and processing satellite signals. The signal processing assembly 230 may comprise circuitry for implementing a low-noise block downconversion (LNB) function. Furthermore, although the signal processing assembly 230 may be colloquially referred to as a “low-noise block downconverter” or “LNB,” in various example implementations it may comprise circuitry operable to perform functions beyond block downconversion of received satellite signals. In the depicted implementation, the signal processing assembly 230 is shown as a single physical assembly mounted to the satellite dish assembly (i.e., it is a subassembly of the satellite dish assembly). In other implementations, however, the signal processing assembly 230 may comprise multiple physical assemblies, one or more of which may reside physically separate from the satellite dish assembly and be connected to the satellite dish via one or more wired and/or wireless links.

In some instances, the satellite dish assembly 200 may be configured to support reception and/or handling of other, non-satellite signals, which may carry non-satellite content. For example, the satellite dish assembly 200 may be configured to support reception and/or handling of terrestrial signal/content. In this regard, the satellite dish assembly 200 may comprise, for example, an antenna component 240 that is configured to receive signals in the bands typically utilized for particular, non-satellite broadcast or communication. The antenna component may be configured to perform at least some of the functions described with regard to the antenna assembly 108 of FIG. 1. In this regard, the antenna component 240 may comprise one or more antennas that may be configured to receive RF signals corresponding to terrestrial broadcasts (e.g., UHF or VHF bands). Furthermore, the antenna component 240 may be configured, in some instances, to support diversity reception.

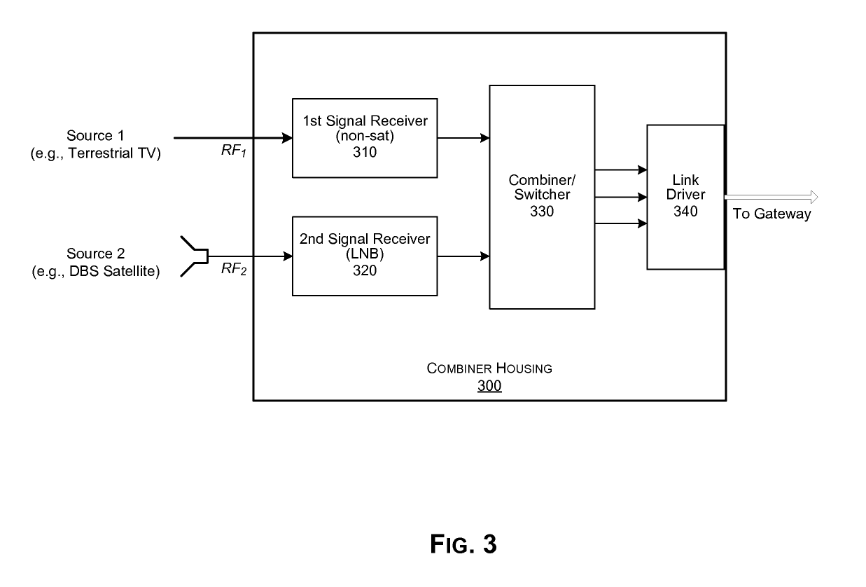

In some example implementations, the satellite dish assembly 200 may be configured to support combining of satellite and non-satellite contents. For example, satellite signals (or satellite content extracted therefrom) captured using the reflector 210 and terrestrial signals (or satellite content extracted therefrom) captured via the antenna component 240 may be processed via the signal processing assembly 230 such that feeds generated by the signal processing assembly 230 may combine satellite content and non-satellite (e.g., terrestrial) content—i.e., a single output signal may carry both satellite and non-satellite (e.g., terrestrial) content. In some instances, satellite and non-satellite content may be combined by stacking them in the corresponding output signal. An example of a signal processing/combining system which may correspond to the signal processing assembly 230 is described in FIG. 3.

FIG. 3 illustrates an example housing component of a satellite television receiver assembly that may support integrated stacking. Referring to FIG. 3, there is shown the signal combining housing (or simply housing) 300. In this regard, the combining housing 300 may correspond to the signal processing assembly 230 (or a portion thereof) of the satellite dish assembly 200 of FIG. 2.

The housing 300 may comprise suitable circuitry, interfaces, logic, and/or code for processing signals obtained from a plurality of sources, and for combining at least portion of content carried thereby. In this regard, the signal sources may comprise, for example, satellite and/or terrestrial head-ends. In some instances, the housing 300 be configured to support use of integrated stacking during combining of signals, for example to enable channel and/or band stacking, to facilitate combining contents corresponding to multiple feeds. For example, the housing 300 may comprise, for example, two signal receivers 310 and 320, a combiner 330, and a link driver 340.

The signal receiver 310 may be configured to receive and process non-satellite signals. In this regard, the signal receiver 310 may comprise circuitry operable to receive and process non-satellite broadcast (RF) signals. For example, the signal receiver 310 may be configured to receive terrestrial TV signals, which may be captured using a suitable antenna(s) assembly. In this regard, the signal receiver 310 may be configured to perform such functions as amplification, filtering, and downconverting on a particular received RF (terrestrial) signals, to enable generating corresponding IF signals, and/or to perform additional functions that enable extraction of content (e.g., demodulation, diversity combining, etc.).

The signal receiver 320 may be configured to receive and process satellite signals. In this regard, the signal receiver 320 may comprise a low-noise block downconverter (LNB), and may comprise circuitry operable to receive and process RF satellite signals, which may be captured via a reflector of a satellite reception assembly. For example, the LNB 320 may be configured to perform such functions as low-noise amplification, filtering, and downconverting on particular received RF (satellite) signals, to enable generating corresponding IF signals. The IF signals may be in, for example, the L-band, half-L-band (950-1450 MHz), extended-L-band (250-2150 MHz, 300-2350 MHz), and the like. The disclosure, however, is not so limited, and the IF signals may span any suitable frequency range. In some instances, the housing 300 may be configured to support reception of multiple satellite signals, and may correspondingly utilize a plurality of LNBs to allow receiving a plurality of satellite (RF) signals, each of which corresponding to a unique/distinct satellite signal, with the signals differing, for example, based on the source or the polarization.

The combiner 330 may be configured to process and combine signals corresponding to a plurality of received RF signals—e.g., outputs of the LNB 320 and the signal receiver 310. For example, the combiner 330 may be operable to amplify, downconvert, filter, and/or digitize at least a portion of the input signals. In some instances, the combiner 330 may be configured to support full-spectrum capture—i.e., to capture an entire spectrum of each of one or more protocols of interest may be concurrently digitized, or to only digitize a portion of the input signals, for example, depending on which channels (or sub-bands) in the signals are selected by client devices (e.g., which television channels are being consumed by the client devices). In some instances, the combiner 330 may be configured to support integrated stacking, whereby portions (e.g., channels or sub-bands) of input signals may be combined into a single output. Once the processing of the input signals (or portions thereof) is complete, the combiner 330 may be operable to recover information carried in the signals (e.g., one or more channels contained therein), and may generate output signals carrying the recovered information. The output signals may be sent to the link driver 340, for transmission thereby (e.g., to the gateway). In some instances, the output signals may be processed in the combiner before being forwarded to the link driver 340. For example, the combiner 330 may be operable to convert to analog, upconvert, filter, and/or amplify the output signals.

The link driver 340 may be operable to process signals generated via the combiner 330 (e.g., comprising recovered information) and generate signals that may be transmitted onto a link to a corresponding link-peer device, such as a gateway/STB (e.g., link 108 to gateway 102 of FIG. 1) in a format supported by the link-peer device. For example, the link driver 340 may be operable to packetize and transmit data received via signals RF₁-RF_{N}, in accordance with one or more networking standards (e.g., Ethernet, Multimedia over Coax Alliance (MoCA), DOCSIS, and the like) to a link-peer device that receives satellite data using such standards. Additionally, or alternatively, the link driver 340 may be operable to perform operations (e.g., digital to analog conversion, modulation, frequency conversion, etc.) for outputting the data according to one or more multimedia standards (e.g., ATSC, DVB-S, ISDB-S, and the like) to enable receiving satellite data by devices using such standards. The output of the link driver 340 may comprise a plurality of IF signals, in a particular range to which the link-peer device (gateway/STB) may tune. For example, each of the IF signals may be in the L-band (950 MHz to 2150 MHz).

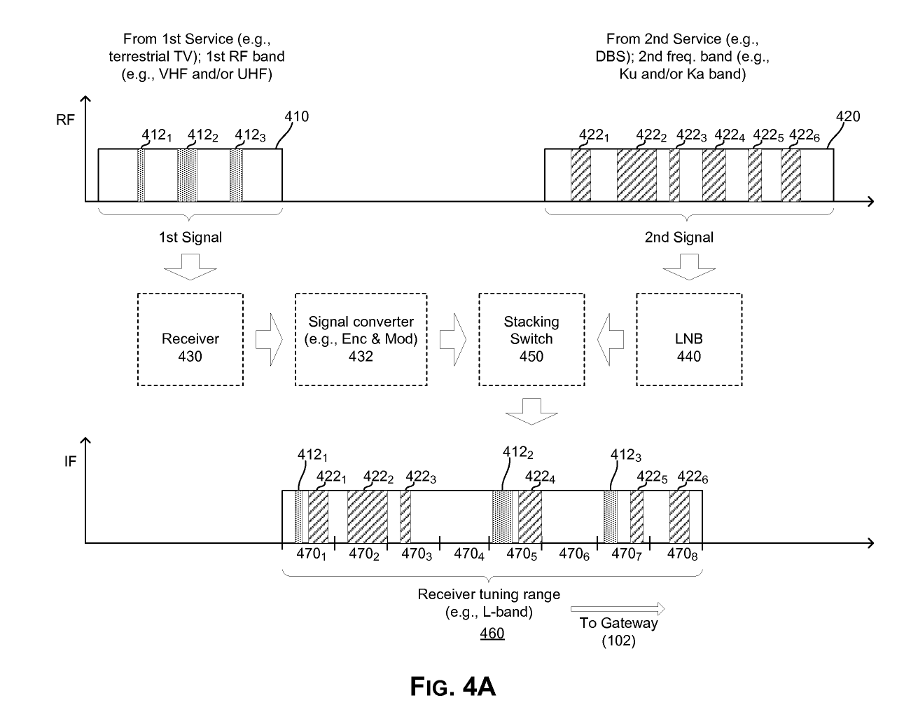

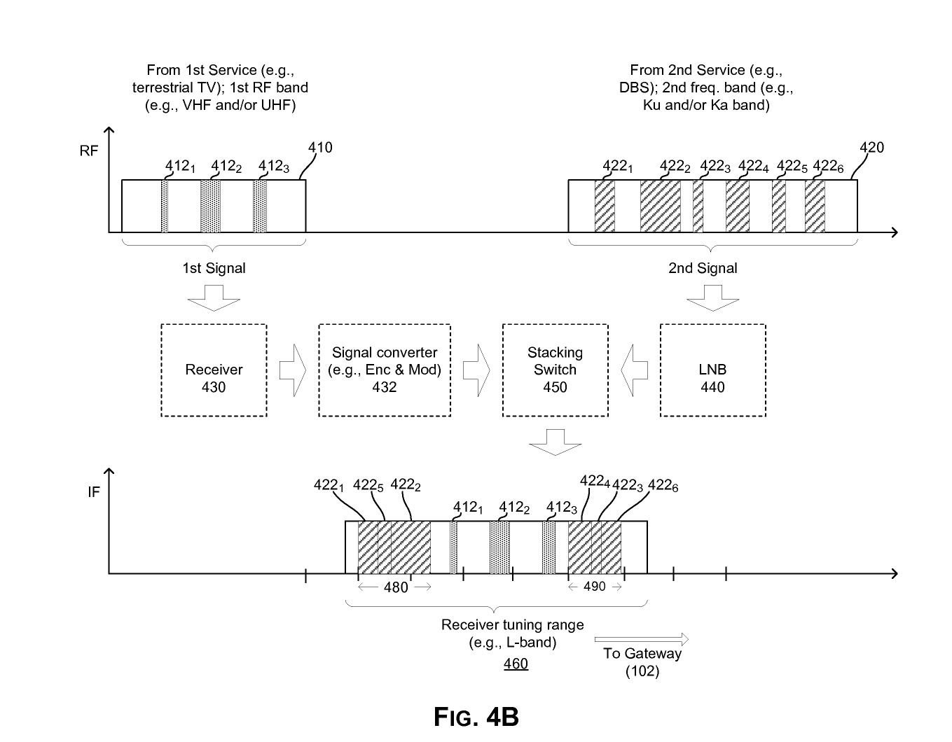

In operation, the housing 300 may be configured to support combining content from different sources, particularly satellite and non-satellite content. For example, the satellite signals may be received and processed via the LNB 320 whereas non-satellite (e.g., terrestrial) signals may be received and processed via the signal receiver 310. The combiner 330 may then be utilized to combine content from the satellite and non-satellite signals. In some instances, the combining performed by the combiner 330 may comprise combining content into a single output (e.g., IF) signals. This may be achieved be converting the content corresponding to one of the sources to appear as content obtained from signals received from the other source. For example, non-satellite (e.g., terrestrial) signals, which may typically correspond to bands different than satellite signal bands, may be processed such that content obtained therefrom (e.g., corresponding to particular channels or sub-bands) may be converted to appear as satellite content. This may comprise demodulating the non-satellite signals and then demodulating them based on a supported satellite standard. Example implementations for processing signals from different sources, to combine them into single output, are provided in FIGS. 4A and 4B.

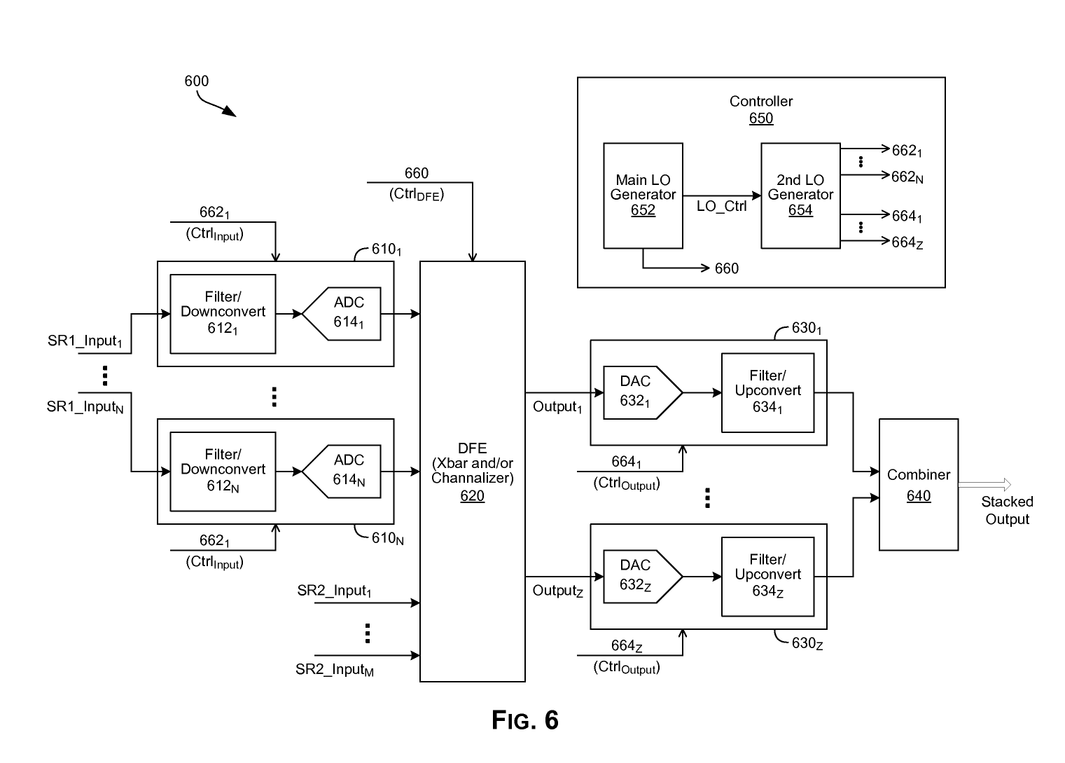

In an example implementation, the housing 300 may be configured to handle and/or support use of channel stacking and/or band stacking, such as during combining of satellite and non-satellite contents. For example, the LNB 320, the signal receiver 310, the combiner 330, and the link driver 340 may be implemented using integrated stacking based architectures. In this regard, integrated stacking based architectures may comprise, for example, filters that may be configured to filter through particular portions (e.g., corresponding to particular channels or sub-bands) in received signals. The integrated stacking based architectures may also comprise use of a multiple-input-multiple-output crossbar (Xbar). In this regard, the Xbar may be configured such that one or more inputs (comprising particular channels or sub-bands) may be combined and mapped to one or more outputs. An example implementation for a stacking architecture is provided in FIG. 6.

FIGS. 4A and 4B illustrates example stacking schemes that may be implemented by a system configured to support use of integrated stacking while combining satellite content and non-satellite content onto a single physical channel for conveyance to a gateway/set-top box (STB). Referring to FIGS. 4A and 4B, there is shown a processing path comprising a receiver 430, a signal convertor 432, a low-noise block downconverter (LNB) 440, and a stacking switch 450. The receiver 430 and the LNB 440 may be substantially similar to the receiver 410 and the LNB 420, respectively, of FIG. 3, for example. The signal convertor 432 may comprise circuitry configurable to convert signals (e.g., IF signals obtained from received RF signals) to match a particular standard and/or interface. For example, the signal convertor 432 may comprise an encoder/modulator circuitry for converting IF signals corresponding to non-satellite (e.g., terrestrial) signals to appear as satellite based IF signals. The stacking switch 450 may comprise circuitry configurable to combine a multiple received signals (or portions thereof) onto a single channel. The signal convertor 432 and/or the stacking switch 450 may correspond to (at least a portion of) the combiner/switch 330 (and, in some instances, at least a portion of the link driver 340) of FIG. 3, for example.

In operation, the processing path comprising the receiver 430, the signal convertor 432, the LNB 440, and the stacking switch 450 may be utilized to enable receiving multiple signals from different sources (e.g., satellite and non-satellite, such as terrestrial), and to combine content from the multiple received signals onto a single output physical channel—e.g., for conveyance to a gateway/set-top box (STB), such as the gateway 102 of FIG. 1 for example. For example, as shown in FIGS. 4A and 4B, the processing path may be configured to enable extracting particular channels (or sub-bands) from two distinct received radio frequency (RF) signals 410 and 420, and to combine/stack the extracted channels (or sub-bands) onto a single intermediate frequency (IF) signal. In this regard, the RF signal 410 may be associated with a first (non-satellite) service (e.g., terrestrial TV broadcast), occupying a first 1st RF band (e.g., corresponding to VHF and/or UHF band) while the RF signal 420 may be associated with a second (satellite) service (e.g., DBS broadcast); occupying a second (and different) RF band, (e.g., corresponding to K, Ku, or Ka band).

During example handling, each of the received signals 410 and 420 may initially be processed, via the receiver 430 and the LNB 440, respectively. This processing may result in corresponding IF signals (not shown). After the received satellite signal (e.g., a DBS signal) 420 is processed via the LNB 440, the output of the LNB 440 is input to the stacking switch 450. The received terrestrial signal (e.g., an ATSC signal) 410 is processed via the receiver 430, and the output of receiver 430 is then input into the signal convertor (encoder/modulator) 432, where it may be converted to appear as satellite based, and the output of the encoder/modulator 430 is then input to the stacking switch 450.

The stacking switch 450 may be configured to combine contents (e.g., channels or sub-bands) of the signals 410 and 420, such as by stacking channels or bands within these signals onto a single output signal. For example, the stacking switch 450 may be configured to frequency division multiplex at least a portion of the received terrestrial signal 410 (e.g., portions 412₁-412₃) and at least a portion of the received satellite signal 420 (e.g., portions 422₁-422₆) onto a common frequency band 460, which is conveyed to a gateway/STB (e.g., the gateway 102) via one or more physical channels (e.g., one or more coaxial cables). In this regard, the common frequency band 460 may correspond to (or be part of) the tuning range of the gateway/STB. For example, the common frequency band 460 may encompass an L-band. The selected portions 412₁-412₃ and 422₁-422₆ may comprise, for example, television channels. Accordingly, since the gateway/STB is operable to tune to the common frequency band 460, the gateway/STB may be enabled to concurrently receive terrestrial content (e.g., TV channels) carried in the portions 412₁-412₃ of the terrestrial signal 410 and satellite content (e.g., TV channels) carried in portions 422₁-422₆ of the satellite signal 420. The selected portions 422₁-422₆ of the satellite signals may comprise, for example, signals from satellite transponders transmitting content (e.g., television channels) that have been selected for consumption by the gateway/STB (e.g., as indicated to the LNB 440 and/or the stacking switch 450 utilizing DiSEqC connection, for example). The selected portions 412₁-412₃ of the terrestrial signal may comprise, for example, most popular television channels, television channels that have been selected for consumption by the gateway/STB (e.g., as indicated to the receiver 430, encoder/modulator 432, and/or stacking switch 450 utilizing DiSEqC connection, for example), and/or signals which have sufficient SNR for reliable reception by the receiver 430.

The stacking switch 450 may be configured to implement different stacking schemes. For example, in the stacking scheme example shown in FIG. 4A, the selected portions 422₁-422₆ of the satellite signal 420 are output into frequency sub-bands 470₁-470₈ of the common frequency band 460 and the selected portions 412₁-412₃ of the terrestrial signal 410 are output on frequency sub-bands between the sub-bands 422₁-422₆ (e.g., in available space(s) within the frequency sub-bands 470₁-470₈, and in-between the portions 422₁-422₆), such that interference between and among the terrestrial content components and the satellite content components of band 460 is kept below a tolerance level. In the stacking scheme example shown in FIG. 4B, the selected portions 422₁, 422₅, and 422₂ of the satellite signal 420 are output onto sub-band 480 of the common frequency band 460, and the selected portions 422₄, 422₃, and 422₆ of the satellite signal 420 are output onto sub-band 490 of the common frequency band 460. The selected portions 412₁-412₃ of the terrestrial signal 410 are output on frequency sub-band between the sub-bands 480 and 490 such that interference between and among the terrestrial content components and the satellite content components of band 460 is kept below a tolerance level.

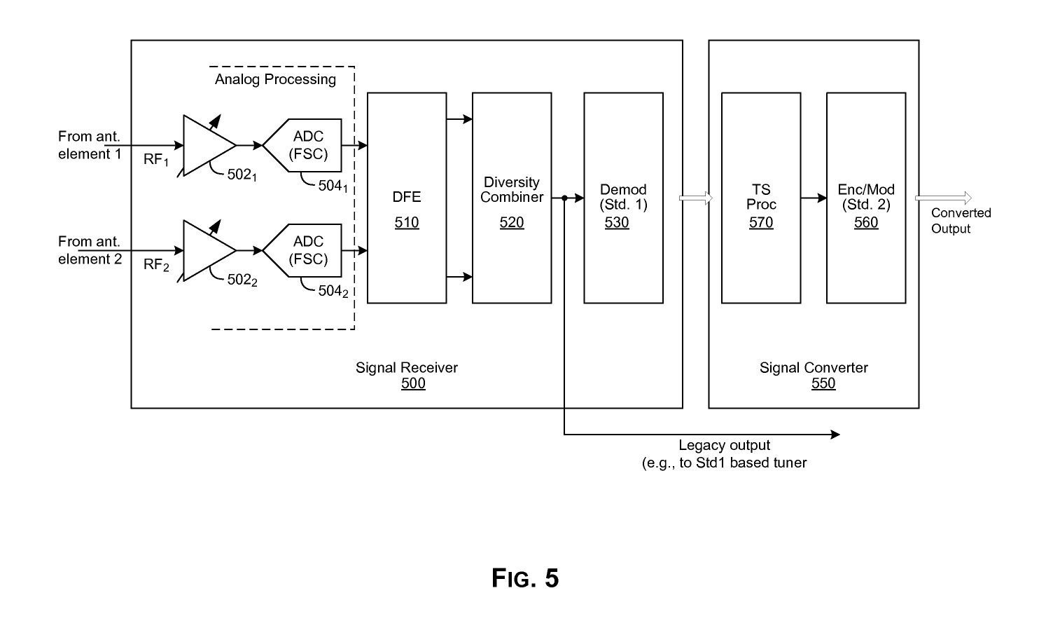

FIG. 5 illustrates an example of a non-satellite receiver and re-modulator that may be used in a system that is operable to combine satellite and non-satellite contents for a seamless user experience. Referring to FIG. 5, there is shown a signal receiver 500 and a signal converter 550.

The signal receiver 500 may comprise suitable circuitry, logic, code, and/or interfaces for receiving and processing signals, particularly non-satellite based radio frequency (RF) signals. The signal receiver 500 may correspond to the receiver 430 of FIGS. 4A and 4B, for example. The signal receiver 500 may be operable to receive and process terrestrial TV (e.g., ATSC) RF signals, which may be captured using any suitable antenna assembly that may be coupled to the signal receiver 500. In this regard, the signal receiver 500 may be configured to perform such functions as amplification, filtering, and conversion (e.g., downconversion and/or analog-to-digital conversion), and/or other additional functions that enable extraction of content (e.g., demodulation, diversity combining, etc.). For example, as shown in the implementation depicted in FIG. 5, the signal receiver 500 may comprise a plurality of amplifiers (e.g., two amplifiers, 502₁ and 502₂, which may be low-noise amplifiers), connected to a corresponding plurality of analog-to-digital convertor (DACs)—e.g., two DACs, 504₁ and 504₂. The amplifiers 502₁ and 502₂ and the DACs 504₁ and 504₂ may be configured to perform initial (analog) processing of a plurality of received RF signals (e.g., RF₁ and RF₂) which may be captured via corresponding antenna elements (antenna elements 1 and 2).

The signal receiver 500 may also comprise a digital front end (DFE) 510, which may be operable to perform digital processing of the received signals. In some instances, the signal receiver 500 may also comprise a diversity combiner 520, which may be configured to perform diversity combining (e.g., of the digital counterparts, as generated by the DFE 510, of the received signals). The signal receiver 500 may also comprise a demodulator (Demod) 520, which may be configured to perform demodulation processing—e.g., to extract the original data-bearing signal from modulated carrier waves. In this regard, the demodulation performed by the demodulator 530 may be configured in accordance with the broadcast/communication standard (Std1) associated with the received signals. For example, “Std1” may refer to ATSC standard, which may be utilized for (digital) terrestrial TV broadcasts. The disclosure, however, is not necessarily limited to any particular standard, and other standards may be supported in the signal receiver 500, such as DVB-T or ISDB-T standards for example. In an implementation, the output of the diversity combine module may be output for use by a gateway/STB that comprises a “Std1” receiver.

The signal converter 550 may comprise suitable circuitry, logic, code, and/or interfaces for converting input signals associated with a first standard, (e.g., IF signals corresponding to received Std1 based RF signals) signals associated with a second standard (e.g., IF signals corresponding to a different broadcast/communication standard, Std2). In this regard, “Std2” may refer to a satellite standard/protocol, such as DVB-S for example. The disclosure, however, is not necessarily limited to any particular standard. The signal receiver 500 may correspond to the signal converter 432 of FIGS. 4A and 4B, for example. The signal converter 550 may comprise, for example, an encoder/modulator (Enc/Mod) 560. In this regard, the Enc/Mod 560 may be configured to perform encoding and/or modulation processing required to generate converted output (e.g., IF signals) that conform to the Std2.

In an implementation, the input to the signal converter 550 (e.g., output of the Demod 530 in the signal receiver 500) a transport stream (e.g., MPEG). Accordingly, the signal converter 550 may be configured to perform processing of the transport stream, via a transport stream (TS) processor 570 for example, such as to harmonize the terrestrial transport stream with a transport stream contained in satellite signals with which the output of the signal converter 550 (particularly the Enc/Mod 560) would be combined. In this regard, the TS processor 570 may be configured to, for example, manipulate PIDs and/or program specific information of the transport stream(s).

FIG. 6 illustrates an example stacking switch as may be in a system that is operable to combine satellite and non-satellite contents for a seamless user experience. Referring to FIG. 6, there is shown a system 600, which may correspond to a stacking architecture that may support integrated stacking (e.g., channel and/or band stacking) of content extracted from received signals associated with different sources.

The system 600 may comprise suitable circuitry, logic, code, and/or interfaces for performing and/or supporting integrated stacking, to provide content stacking (e.g., particular channels and/or sub-band), such as during reception and/or processing of a plurality of input radio frequency (RF) signals associated with different sources. For example, the system 600 may be utilized to provide integrated stacking of satellite and non-satellite (e.g., terrestrial) contents that may be extracted from received satellite and non-satellite (e.g., terrestrial) RF signals, for example as described with respect to FIGS. 4A and/or 4B. In this regard, the system 600 may correspond to, for example, the stacking switch 450.

As shown in the implementation depicted in FIG. 6, the system 600 may be configured to support reception of 2 different sets of input signals: SR1_Input₁-SR1_Input_{N}, corresponding to a first source (e.g., satellite broadcast), and SR2_Input₁-SR2_SR2_Input_{M}, corresponding to a second source (e.g., terrestrial broadcast). In this regard, the system 600 may comprise, for example, plurality of input processing modules 610₁-610_{N} (e.g., N, where N is the number of input signals in the first group of input signals), a digital front end (DFE) 620, a plurality of output processing module modules 630₁-630_{Z} (e.g., Z, where Z correspond to the total number of inputs—i.e., Z=M+N), a combiner 640, and controller 650.

Each of the input processing modules 610₁-610_{N} may be configurable to process the inputs handled thereby such that it may be suitable for use within the DFE 620. The input processing modules 610₁-610_{N} may be utilized in an example embodiment where the DFE 620 may be configured particularly to handle signals similar to the ones in the second group (i.e., SR2_Input₁-SR2_Input_{M}). For example, each input processing module 610ᵢ may be operable to perform filtering downconverting and (via a filter/downconvert block 612ᵢ) and analog-to-digital conversion (via an ADC block 614ᵢ).

The DFE 620 may comprise suitable circuitry, logic, interfaces and/or code for performing various signal processing functions, such as I/Q calibration, equalization, channelization, or the like. The DFE 620 may also be configured to provide crossbar (Xbar) switching function crossbar, whereby one or more inputs of the DFE 620 may be mapped to one or more outputs of the DFE 620. For example, the DFE may be configured to generate up to Z outputs (e.g., output₁-output_{Z}), where Z may be equal to a total number of inputs—i.e., Z=M+N.

Each of the output processing modules 630₁-630_{Z} may be configurable to process one of the outputs (e.g., Z output) generated by the DFE 620. For example, each output processing module 630ᵢ may be operable to perform digital-to-analog conversion (via a DAC block 632ᵢ) and filtering and upconverting (via a filter/upconvert block 634ᵢ).

The combiner 640 may be configured to combine the plurality of outputs (after processing via output processing modules 630₁-630_{Z}). In this regard, the combiner 640 may be operable combine the outputs of the output processing modules 630₁-630_{Z} (which each may be at a different frequency) such that they can be combined onto one or more physical channels (e.g., a coaxial cable), for conveyance to the gateway/STB for example.

The controller 650 may be configured to control operations of one or more other components of the system 600, such as by generating control signals. In this regard, control signals may comprise enable/disable signals, clocking signals, or the like. For example, the controller 650 may comprise two local oscillator (LO) generators, 652 and 654. In this regard, the LO generator 652 may be utilized as a main LO generator, being used, for example, to generate such control signals as Ctrl_{DFE} 660, which may be a control signal (e.g., clock) for controlling the DFE 620, and LO_Ctrl, which may be used in controlling the other (secondary) LO generator 654. The (secondary) LO generator 654, may then be generated (e.g., based on timing of the DFE 620), in generating a plurality of input control signals (Ctrl_{Input}) 662₁-662_{Z} for controlling (e.g., clocking) the input processing modules 610₁-610_{N}, and generating a plurality of output control signals (Ctrl_{Output}) 664₁-664_{Z} for controlling (e.g., clocking) the input processing modules 630₁-630_{Z}.

In operation, the system 600 may be configured to implement integrating stacking of a plurality of inputs. For example, the system 600 may be configured to implement one of the integrated stacking schemes described in FIGS. 4A and 4B. In this regard, the sets of inputs SR1_Input₁-SR1_Input_{N} and SR2_Input₁-SR2_Input_{M}, may correspond to the satellite signal 420 and the terrestrial signal 410, respectively, of FIGS. 4A and 4B for example. Configuring the system 600, to implement the desired stacking scheme, may comprise configuring one or more of the components of the system 600. For example, the mapping performed in the DFE 620 and/or the combining performed in the combiner 640 may be configured based on the particular stacking scheme implemented by the system 600. In this regard, the mapping performed in the DFE 620 may be configured to achieve the corresponding stacking of sub-bands/channels of the two different inputs (satellite and terrestrial) onto the corresponding single output. Similarly, the combining performed in the combiner 640 may be configured based on the required configuration for the output signals (e.g., the common frequency band 460 of FIGS. 4A and 4B).

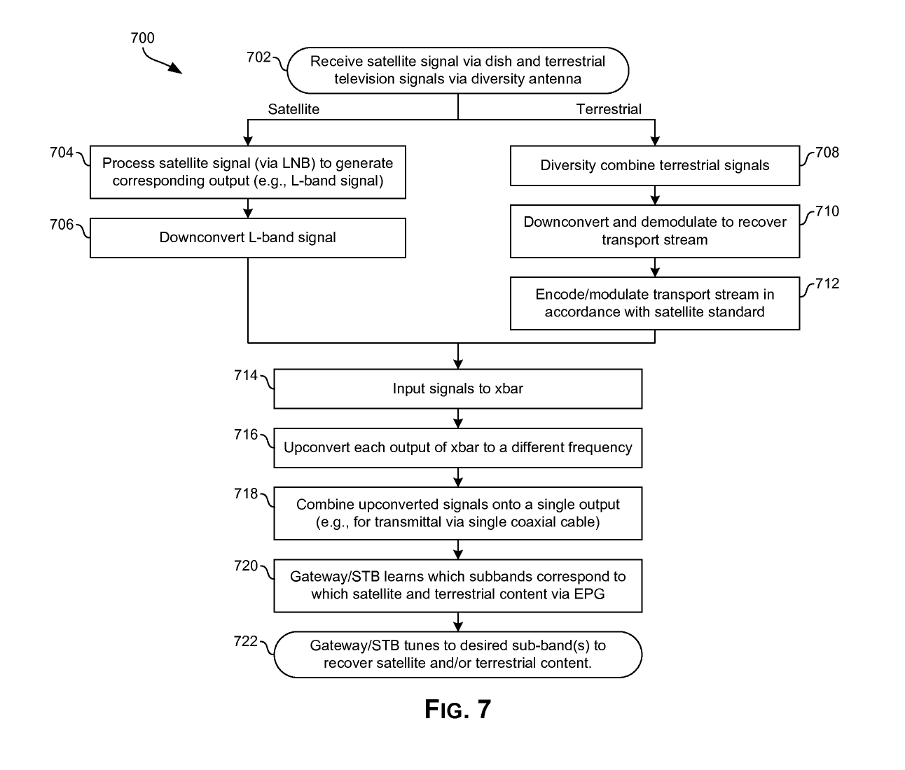

FIG. 7 illustrates an example flow chart of a process for receiving and combining of satellite and non-satellite contents for a seamless user experience. Referring to FIG. 7, there is shown a flow chart 700 comprising a plurality of example steps that may be performed in a system that is configured to receive and combine satellite and non-satellite contents, such as using integrate stacking solutions, for a seamless user experience.

In step 702, the system may receive multiple signals, including a satellite signal (e.g., via a satellite dish) and terrestrial television signals (e.g., via a diversity antenna). In this regard, the antenna used to receive terrestrial television signals may be mounted to and/or integrated with the satellite dish. The signals may then be processed (e.g., concurrently). In step 704, the system may process the satellite signal (e.g., via LNB), to corresponding output which may be an L-band signal. In step 706, the output L-band signals (corresponding to the processed received satellite signal) may be down-converted. Concurrent with steps 704 and 706, the system may, in steps 708-712, process the received terrestrial television signals. In this regard, in step 708, the received terrestrial signals may be diversity combined, to generate a corresponding combined terrestrial signal; then in step 710, the combined terrestrial signal may be down-converted and demodulated, to obtain a corresponding output—e.g., recover a transport stream; and then in step 712, the corresponding output (e.g., transport stream) may be encoded and modulated according to the standard utilized for the received satellite signal (e.g., DVB-S).

In step 714, the signals resulting from processing the satellite signal (step 706) and processing the terrestrial signals (step 712) may be input to a crossbar (Xbar) module, which may enable stacking of the different contents. In step 716, the outputs of the crossbar may be up-converted to frequency sub-bands in a tuning band of target device (e.g., gateway/STB), resulting in a frequency division multiplexed (FDM) signal. In step 718, the FDM signal comprising satellite and terrestrial content may be output to the gateway/STB. In step 720, the gateway/STB may learn (e.g., using an electronic programming guide or EPG) which sub-bands correspond to which satellite content and which sub-bands correspond to which terrestrial content. In step 722, the gateway/STB tunes to the desired sub-band(s) to recover terrestrial and/or satellite content. In this manner, a user of the gateway/STB can receive switch between satellite and terrestrial content, and/or concurrently receive satellite and terrestrial content if the gateway/STB has multiple tuners, without having to switch between inputs/sources.

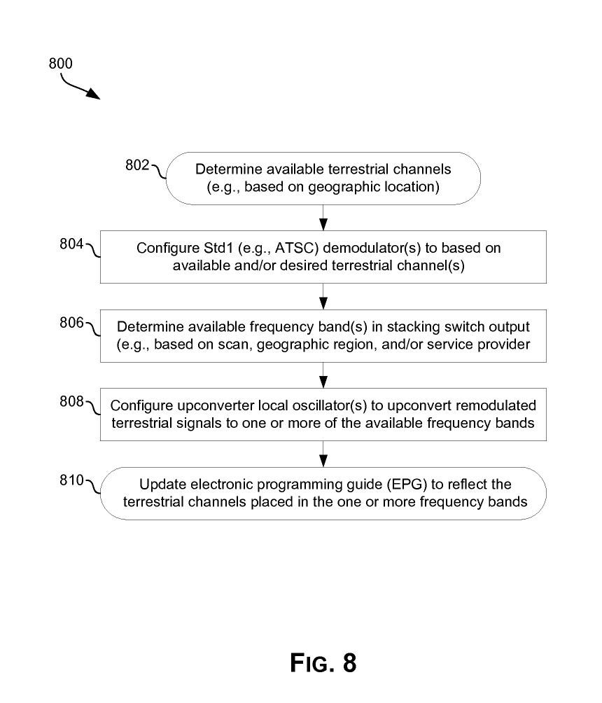

FIG. 8 illustrates an example flow chart of a process for configuring a system for receiving and combining of satellite and non-satellite contents for a seamless user experience. Referring to FIG. 8, there is shown a flow chart 800 comprising a plurality of example steps that may be performed to configure a system to receive and combine satellite and non-satellite contents, such as using integrate stacking solutions, for a seamless user experience.

In step 802, the system may determine available terrestrial channels (e.g., based on geographic location and/or based on a scan of terrestrial frequencies). In step 804, a Std1 receiver, which may be a receiver operable to receive terrestrial signals configured according to a terrestrial standard Std1, may be configured based on the available and/or desired terrestrial channels. This configuration may comprise, for example, setting the frequencies of one or more filters and/or local oscillators (LOs).

In step 806, the system may determine which frequencies sub-bands in an output of a stacking switch (e.g., the stacking switch 450 of FIGS. 4A and 4B) can be used for terrestrial content. In this regard, gateway/STBs may typically be configured to expect particular sub-bands (e.g., sub-bands 470₁-470₈ of FIG. 4A, and sub-bands 480 and 490 of FIG. 1B) in their tuning range (common frequency band 460) to be utilized for satellite content. By placing terrestrial content between such sub-bands (e.g., between two or more of the sub-bands 470₁-470₈ of FIG. 4A, and between the sub-bands 480 and 490 in FIG. 4B) legacy gateway/STBs may be unaffected while gateway/STBs configured to support combined satellite and terrestrial on a single physical channel may be able to receive both satellite and terrestrial content by tuning to the appropriate frequency.

In step 808, the system may be configured to place terrestrial content in the available sub-bands determined in step 806. This configuration may comprise, for example, configuring of filter and/or LO frequencies. In step 810, an electronic programming guide (EPG) may be updated to reflect the addition of the terrestrial content to the signal output to the gateway/STB.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for combined terrestrial and satellite content for a seamless user experience.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. A system, comprising:
a signal reception assembly that is configured to receive a first signal from a first source and a second signal from a second source; and
a processing circuitry that is configured to:
process the first signal and the second signal, wherein the processing comprises converting the first signal to match at least some characteristics of the second signal; and
generate an output signal based on the processing of the first signal and the second signal, wherein:
the output signal comprises one or more portions from each of the first signal and the second signal, and
the one or more portions are stacked within the output signal.

2. The system of claim 1, wherein the first source comprises a first one of a satellite broadcast source and a terrestrial television broadcast source, and the second source comprises a second one of the satellite broadcast source and the terrestrial television broadcast source.

3. The system of claim 1, wherein the signal reception assembly comprises a satellite signal reflector, configured for capturing satellite signals.

4. The system of claim 1, wherein the signal reception assembly comprises an antenna component, configured for capturing terrestrial television signals.

5. The system of claim 1, wherein the one or more portions comprise channels or sub-bands.

6. The system of claim 1, wherein the processing circuitry is housed in the signal reception assembly.

7. The system of claim 1, wherein the signal reception assembly is operable to communicate the output signal to a gateway device that distributes content from the output signal, corresponding to the one or more portions, to one or more client services in a network serviced by the gateway device.

8. The system of claim 7, wherein the gateway device comprises a satellite set-top box (STB).

9. The system of claim 1, wherein the processing circuitry is operable to communicate the output signal over a single link that is configured based on one or more of: a coaxial cable connection, a twisted-pair connection, a Multimedia over Coax Alliance (MoCA) connection, an Ethernet connection, or a Direct Broadcast Satellite (DBS) based connection.

10. The system of claim 9, wherein the processing circuitry is operable to combine the one or more portions based on configuration of the single link.

11. A method, comprising:
receiving, by a signal reception assembly, a first signal originating from a first source and a second signal originating from a second source;
processing the first signal and the second signal, wherein the processing comprises converting the first signal to match at least some of characteristics of the second signal; and
generating an output signal based on the processing of the first signal and the second signal, wherein:
the output signal comprises one or more portions from each of the first signal and the second signal, and
the one or more portions from each of the first signal and the second signal are stacked within the output signal.

12. The method of claim 11, wherein the first source comprises a first one of a satellite broadcast source and a terrestrial television broadcast source, and the second source comprises a second one of the satellite broadcast source and the terrestrial television broadcast source.

13. The method of claim 11, wherein the signal reception assembly comprises a satellite signal reflector, configured for capturing satellite signals.

14. The method of claim 11, wherein the signal reception assembly comprises an antenna component, configured for capturing terrestrial television signals.

15. The method of claim 11, wherein the one or more portions comprise channels or sub-bands.

16. The method of claim 11, comprising communicating the output signal to a gateway device that distributes content from the output signal, corresponding to the one or more portions, to one or more client services in a network serviced by the gateway device.

17. The method of claim 16, wherein the gateway device comprises a satellite set-top box (STB).

18. The method of claim 11, comprising communicate the output signal over a single link that is configured based on one or more of: a coaxial cable connection, a twisted-pair connection, a Multimedia over Coax Alliance (MoCA) connection, an Ethernet connection, or a Direct Broadcast Satellite (DBS) based connection.

19. The method of claim 18, comprising combining the one or more portions based on configuration of the single link.

20. A system, comprising:
one or more first reception components for receiving and processing one or more radio frequency (RF) signals originating from a first source;
one or more second reception components for receiving and processing one or more RF signals originating from a second source;
one or more convertor components for converting signals originating from one of the first source and the second source to match at least in part signals originating from other one of the first source and the second source; and
a signal switching component that is configured to perform crossbar switching that allows combining and mapping one or more inputs corresponding to each of the first source and the second source, onto a plurality of outputs of the signal switching component, wherein the combining is based on integrated stacking of the one or more inputs corresponding to each of the first source and the second source.
